(19) United States
(12) Patent Application Publication
(10) Pub. No.: US 2010/0205054 A1
(43) Pub. Date: Aug. 12, 2010

(54) CONTINGENCY-BASED ELECTRONIC AUDITING

(76) Inventor: Dean W. Hahn-Carlson, Lilydale, MN (US)

Correspondence Address: CRAWFORD MAUNU PLLC, 1150 NORTHLAND DRIVE, SUITE 100, ST. PAUL, MN, 55120, US

(21) Appl. No.: 12/700,387

(22) Filed: Feb. 4, 2010

Related U.S. Application Data
(60) Provisional application No. 61/150,516, filed on Feb. 6, 2009.

(51) Int. Cl. G06Q 20/00; G06Q 10/00; G06Q 30/00

(52) U.S. Cl. 705/14.17; 705/14.1; 705/14.34; 705/14.35; 705/30; 705/34; 705/44

(57) ABSTRACT

Transaction auditing involving the provision of payment from a third-party to a transaction party is facilitated. In accordance with one or more example embodiments, a transaction auditing approach involves processing payment from a third party to one of a buyer and seller involved in a transaction to which the third-party payment is applicable. When an auditing criterion is met, such as when the buyer and seller agree to contract terms or when the buyer pays the seller, payment from the third party is authorized and processed based on the authorization.

### RELATED PATENT DOCUMENTS

This patent document claims the benefit, under 35 U.S.C. §119(e), of U.S. Provisional Patent Application Ser. No. 61/150,516 filed on Feb. 6, 2009, and entitled “Payment Processing System and Approach with Contingent Third-Party Payment;” this patent document is fully incorporated herein by reference.

### FIELD OF THE INVENTION

The present invention is directed to electronic transaction data auditing and, more specifically, to systems and methods for auditing transaction data for continent-payment based conditions.

### BACKGROUND

Operational management and data processing of contractual and transactional interactions between buyers and sellers involved in the exchange of products and/or services for purposes of commerce have typically been labor and time intensive. Where additional transaction parties enter into the picture, the interaction becomes more complex. In particular, where transactions that are electronically processed involve multiple parties, with various contingencies relating to transaction event authorization, such as payment authorization, the complexity of such interaction has limited the ability to process such transactions electronically or otherwise. Generally, the processes of managing transactions between business entities have been unduly burdensome and inefficient.

Individual interactions between transaction parties are often characterized by specific contracts, payment rules and other financial processing characteristics. Where more than two parties are involved, this interaction becomes increasingly complex. For example, certain sellers may require payment terms such as a net payment due within a particular time period, payment to a particular financial institution or payment in a particular currency. In addition, certain sellers may require different payment terms for different contracts. Where third parties are involved, payment interaction may involve contractual conditions that relate to one or more other contractual and/or transaction event conditions involving other parties. Entity-specific and transaction-specific variances in payment terms can be particularly difficult to manage and track.

When a transaction reaches the payment step, financial institutions for different parties to the transaction must interact with each other. This interaction typically involves complex agreements and associations that facilitate the transfer of funds, often relying upon transaction conditions that may not be available to certain financial institutions associated with transaction parties. In particular, disparate electronic systems operate independently and have generally not been amenable to operation on a highly interactive nature. At times, there can be delays in payment or disputes regarding terms of payment, or a complete lack of ability to electronically communicate necessary information upon which payment is based. In addition, previous approaches, often involving human interaction, are highly susceptible to error. Interaction complexity, delay and error, as well as a multitude of other characteristics of transaction payment can cost one or more parties to a transaction (including financial institutions) a significant amount of funds.

Most industries are quite competitive and any cost savings are therefore important. Administrative and processing costs are targeted for reduction as no revenue is directly generated from administrative functions. However, administrative costs associated with commercial transactions have been difficult to reduce in the current business environment with widely diffused data.

The above and other difficulties in the management and processing of transactions, particularly those involving or benefiting from electronic processing and automation involving multiple transaction parties have presented challenges to transaction entities and processing systems involved in various aspects of transactions, including accounts payable aspects, third-party payment aspects and others.

### SUMMARY

The present invention is directed to overcoming the above-mentioned challenges and others related to the types of devices and applications discussed above and others related thereto. The present invention is exemplified in a number of implementations and applications, some of which are summarized below.

According to an example embodiment of the present invention, an automated payment processing system processes payment for transactions involving the provision of goods and/or services between seller and buyer parties, by facilitating payment from a third-party participant to one of the seller and buyer parties in response to a qualifying event in the transaction involving the buyer and seller.

In connection with another example embodiment of the present invention, an automated transaction processing system processes electronic transactions between transaction parties including buyers, sellers and an independent third party that provides a contingent payment to one of the transaction parties. Each of a multitude of transaction data sets, respectively pertaining to different transactions involving a buyer, a seller and related contract data, are processed according to stored contract data and business rules including third-party business rules. The system includes a computer-based auditing engine (circuit) and a computer-based payment processor. The auditing engine is configured to audit the transaction data set using the stored business rules and contract data to determine a condition of payment authorization for a payment to be made to the seller on behalf of the buyer, and further to audit a contingent third-party payment for the transaction in response to the fulfillment of a transaction condition specified by business rules for the third party, to determine a condition of payment authorization for the third-party payment. The computer-based payment processor is configured to process electronic payment to the seller on behalf of the buyer in response to the determined condition of payment to be made to the seller, and to process payment to one of the buyer and the seller in response to the determined condition of payment authorization for the third-party payment.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1 shows an arrangement and approach for electronically processing transactions involving multiple parties with contingent payment from disparate transaction participants, according to an example embodiment of the present invention;

FIG. 2 shows an arrangement and approach for the electronic processing of payment for a shipping transaction involving two or more carriers and respective shipping segments with related jurisdiction-based third-party payment, according to another example embodiment of the present invention;

FIG. 3 shows a flow diagram for electronic transaction processing involving a third party payment, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of transaction processing and management approaches, and has been found to be particularly useful for applications involving the electronic authorization and processing of transaction data to audit/evaluate third-party payment for a particular transaction. While the present invention is not necessarily limited to such approaches, various aspects of the invention may be appreciated through a discussion of various examples using these and other contexts.

According to an example embodiment of the present invention, an automated payment processing system includes a computer-based circuit that uses data sets received from various sources to evaluate and process electronic payments for transactions involving the provision of goods and/or services between seller and buyer parties. The payments evaluated include a payment that is authorized based upon a buyer's receipt of goods and/or services from a seller, and a third-party payment made to one or both of the buyer and seller on behalf of a third-party participant that is separate from the buyer and seller. This third-party payment is evaluated and effected in response to a qualifying event pertaining to the transaction involving the buyer and seller, such as an event-based criterion specified in or otherwise discernable from data within a transaction data set used to evaluate and authorize payment on behalf of the buyer, or in/from external data that is related to the transaction.

The transaction parties, including the third-party participant, provide information including contracts and business rules for transactions, including information characterizing conditions upon which the third-party payment is to be made. The automated payment processing system uses this information in automatically facilitating the payment as discussed above, in response to a qualifying event.

While a multitude of disparate qualifying events may be applicable for various embodiments, one example event involves payment made to a seller on behalf of the buyer (e.g., the criterion for a buyer receiving a third-party payment may be based upon the completion of the transaction in accordance with the buyer's payment). Another example involves using an externally-generated event as the criterion for evaluating third-party payment, where such a criterion may involve the receipt of data from the third party (or another party) that is used to determine that the criterion has been met for the transaction.

The third-party payment is effected to provide funds for a variety of different reasons. In some applications, a third-party payment approach as described above is implemented with a subsidy or other discount approach. In one example, a government (e.g., country, state or territorial government) acts as a third party to provide payment in response to another transaction. This approach may be implemented to promote the use of a particular contractor (e.g., hailing from the government's territory, or falling under a certain status such as a minority-owned status), or to provide a subsidy for goods or services, such as to provide a farming subsidy. Other contingent payments may involve those made to airlines according to transportation contracts that involve a government-type entity. In another example, a third-party manufacturer provides a rebate to a buyer in response to the buyer purchasing the manufacturer's goods from a seller.

In other applications, a third-party payment approach as described above is implemented with a non-government approach involving a third party otherwise interested in the transaction. For example, one embodiment is directed to a third-party payment made to one or both of a buyer and seller in a transaction to provide a rebate for goods and/or services associated with the transaction. Such rebates may be provided by a manufacturer whose goods are sold by a seller to a buyer, with the rebate electronically applied to one or both of the buyer and seller involved in the transaction. Other contingent third-party-based payments involve payments made in response to a transaction condition such as service work having been completed, or a buyer making payment of a deduction.

In other applications, a third-party payment is electronically processed in connection with the facilitation of payment for a transaction involving a buyer and seller, with funds provided to the seller on the buyer's behalf by a third party in response to a transaction condition. For example, one embodiment is directed to an insurance-based transaction involving payment made by a third-party insurance company with a buyer-provided deductible, where a buyer party contracts with a seller party to execute insurance-based repairs or to provide goods to replace items covered by insurance. The third-party insurance company makes a payment to the seller that is contingent upon the buyer's provision of funds to cover a deductible amount.

In some applications, the transaction system electronically facilitates the provision of funds on behalf of the buyer, and provides the buyer's funds to the third-party insurance company (e.g., to an appropriate account at a financial institution). In response, the system facilitates the provision of funds on behalf of the insurance company to the seller in accordance with an amount owed to the seller for the repair of goods or services associated with the insurance-based transaction.

In other applications, the transaction system electronically facilitates the provision of funds on behalf of the buyer, and provides the buyer's funds directly to the seller. In response, the system further facilitates the provision of funds on behalf of the insurance company to the seller in accordance with an amount owed to the seller, less an amount of buyer's funds provided to the seller for the repair of goods or services associated with the insurance-based transaction.

In accordance with one or more example embodiments discussed above, the electronic facilitation of third-party payment for contingent payments, rebates and other applications involve the presentation of third-party funds in a relatively rapid manner, often nearly coinciding with the occurrence of a transaction condition (e.g., payment) upon which the third-party payment is based. In some applications, some of which are described above, a pay-through-payment approach is implemented wherein third-party or otherwise contingent funds are made available on behalf of owed transaction parties to which the payment is accounted, for providing funds on behalf of the owed transaction parties.

In other example embodiments, and as may be implemented with one or more of the above embodiments, third-party payments are made for transactions involving a currency conversion to be made in connection with at least one payment between transaction parties. For instance, where a third party provides contingent funds, attributed to a buyer, in a currency in which a seller is to be paid, the processing system automatically facilitates the diversion of funds provided by the third party for the buyer. The diverted funds are provided to the seller on behalf of the buyer, thus avoiding currency conversion for at least a portion of an amount owed by the buyer to the seller. Any remaining funds are provided on behalf of the buyer to the seller, with an appropriate currency conversion made.

Computer-based circuits (e.g., computer processors) effecting third-party payments as discussed herein are accordingly configured (e.g., programmed and reprogrammed) to use and implement a variety of disparate types of contingency data for evaluating criterion established for a multitude of disparate third parties and the payments related thereto. In this context, such a circuit is configured to communicate with different types of systems, using different types of communications protocols tailored for each particular application (e.g., buyer systems, seller systems and other party systems). The circuit accesses stored data that is used to configure the circuit's operation in accordance with individual entities participating in transactions, to effect transaction-specific operational capabilities of the circuit as defined by inputs (e.g., business rules, contract data) for the particular combination of entities participating in each transaction.

The system also permits third-party interaction, or restricted vision, into an aspect of the transaction upon which third-party payment criterion is based to maintain the integrity of data that is not part of the particular transaction and/or that is not relevant to the third-party access (e.g., buyer-based authorization rules may be proprietary and unnecessary for the third party). For instance, third-party payment systems operating independently from any buyer and/or seller system for a transaction automatically have access to criterion pertaining to the third party payment, such as notification that payment has been made to a seller for a transaction. This criterion may be maintained confidentially relative to the buyer and/or seller (e.g., the amount of or other details regarding the payment may be restricted), yet sufficient information is used to effect the third-party payment. In many applications, the computer-based circuit accesses third-party rules/criterion directly such that no third-party system needs access to any transaction data, and the third-party payment is evaluated (audited) and made both automatically and independently from a third-party or a third-party system.

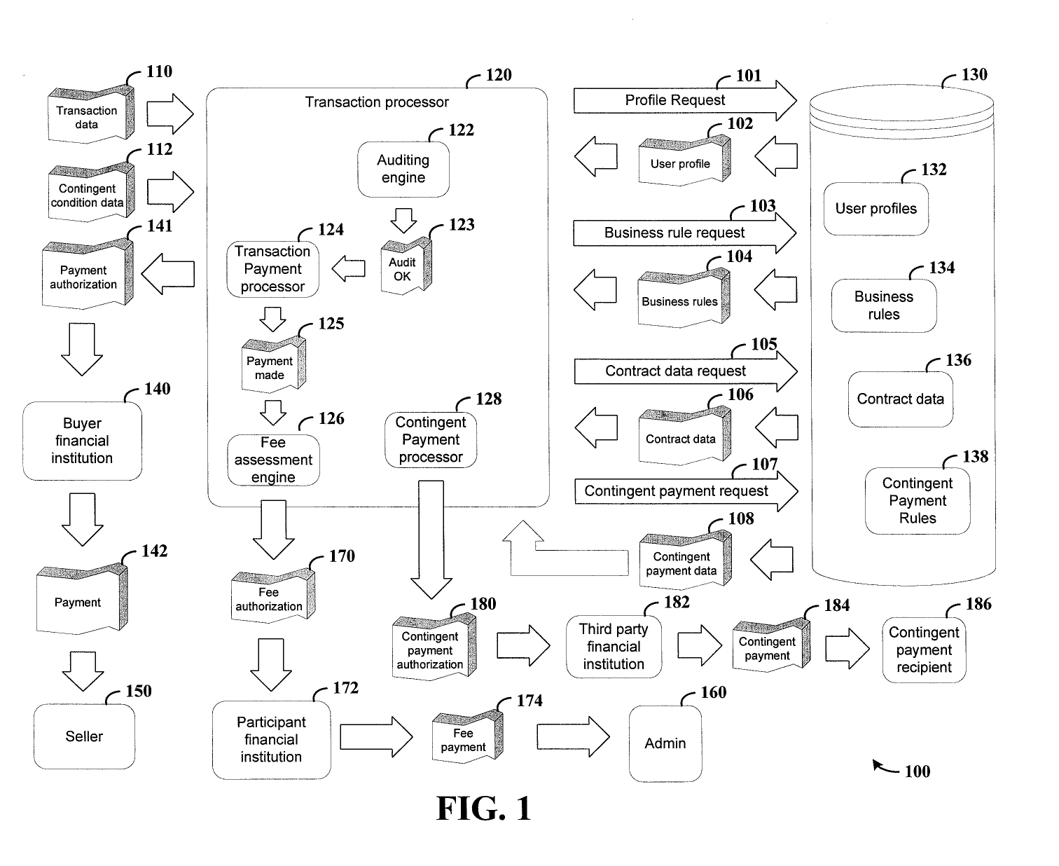

Turning now to the figures, FIG. 1 shows an arrangement and approach 100 for electronically processing transactions involving multiple parties with contingent payment from disparate transaction participants, according to another example embodiment of the present invention. The arrangement 100 includes a transaction processor 120 (a computer-based circuit), implemented in common and/or disparate processing devices and locations, that facilitates both payments for transactions between buyers and sellers, as well as contingent-payments related to the transactions (e.g., the processor 120 is programmed with an algorithm to carry out various functions as described herein). To facilitate this processing, the transaction processor 120 implements an auditing engine 122 to audit transaction data 110 and/or contingent condition data 112, a transaction payment processor 124 and a contingent payment processor 128 for respectively processing transaction payment (i.e., for goods and/or services) and a contingent payment for appropriate transactions and in accordance with the auditing engine. Processing payment may involve, for example, generating electronic payment data, recording data to track the payment and debiting and/or crediting one or more accounts to reflect the transfer of funds for the payment. An administrator 160 (e.g., entity/entity system) operates the transaction processor and appropriately facilitates contracting and interaction with transaction participants including buyers, sellers, contingent payment parties and other related participants such as financial institutions for the above.

A data storage arrangement 130, to include one or more data storage circuits and/or devices, stores user profiles 132, business rules 134, contract data 136 and contingent payment rules 138 for use in processing transactions. Generally, the data stored in the data storage arrangement 130 is stored in a computer-readable format for use in executing predefined audit functions at the auditing engine 122.

When processing transaction data pertaining to different transaction parties and one or more transactions in which the parties participate, the auditing engine 122 uses the data from the data storage arrangement 130 for different participating parties to process readable code in the transaction data and accordingly audit the transaction. The audit may involve, for example, the generation of a payment term that relates to the transaction, using information from different transaction parties together with common rules (i.e., computer-readable code used in executing functions) for processing transactions. Where contingent payment aspects of transactions are audited, the auditing engine 122 similarly performs auditing functions by processing readable code in the contingent condition data 112 and transaction party data 110 to audit the contingent payment (i.e., to ensure conditions are proper and/or ripe for making such a payment). Accordingly, each audit process may be configured individually for each audited transaction, based upon the combination of parties involved in the transaction.

Generally, the auditing engine 122 accesses the data storage arrangement 130 for making profile, business rule or contract data requests 101, 103 and 105. In response, the data storage arrangement 130 returns appropriate data including one or more of user profile data 102, business rules 104 and contract data 106. Where a contingent payment is to be made, the auditing engine 122 similarly uses a contingent payment information request 107, with the data storage arrangement 130 returning contingent payment data 108 in response to the request.

When the auditing engine 122 indicates that a particular transaction, or aspects of a particular transaction, to which the transaction data 110 applies is payable, a message 123 (e.g., a computer instruction) is sent to the transaction payment processor 124, which responds by generating a payment authorization 141 that is sent to a buyer financial institution 140. In these contexts, the buyer financial institution 140 may be an external institution operating independently from the transaction processor 120, operating with the transaction processor 120 (e.g., as a transaction participant storing user profiles 132 and/or business rules 134), or as part of the transaction processor 120 operating in connection with the administrator 160.

In response to the payment authorization 141, the buyer financial institution creates a payment 142 that is provided to the seller 150. In some applications, the payment 142 is provided independently to the seller by, for example, transferring funds to a seller account at a financial institution or sending a payment via mail or other service, without involving the transaction processor 120. Where the seller 150's financial institution interacts with the transaction processor 120, or is operated as part of the transaction processor 120, payment is selectively carried out by the transaction processor 120. For instance, the transaction processor 120 may directly transfer funds between accounts for the buyer and the seller, where both maintain accounts with a financial institution operated with the transaction processor 120.

In response to a payment made (data 125) for the transaction data 110 or contingent condition data 112, the auditing engine 122 processes a contingent payment made to one or more transaction parties and interacts with the contingent payment processor 128 to facilitate the contingent payment. In this regard, where a contingent payment is appropriate, such as in view of a particular contingent payment condition such as a portion of a transaction being completed or a payment being made, the contingent payment processor 128 generates a contingent payment authorization 180 that is provided to a third party financial institution 182 for making the payment. Depending on the application, as specified in the contingent payment data 108, and as may be consistent with the example embodiments described above, the third party financial institution 182 may facilitate payment on behalf of a multitude of users. For instance, a contingent payment may be facilitated from government entity promoting business in its geographical boundaries, a transaction party such as the seller providing a rebate, or an indirect transaction party such as a manufacturer whose goods are sold by the seller 150.

Once authorized, the third party financial institution 182 provides a contingent payment 184 to a contingent payment recipient 186, such as a buyer or seller participant in the transaction. In some applications, the third party financial institution is operated in connection with the transaction processor 120 in a manner similar to that described with the payment 142 made to the seller 150 above. In these applications, the transaction processor 120 selectively processes payment internally and/or with financial institutions participating in the transaction processing. Furthermore, where appropriate, the contingent payment is provided among other transaction funds (e.g., where a buyer owes a seller a first amount, and where that buyer is owed a contingent payment, the contingent payment may be provided to the seller to cover some or all of an amount owed by the buyer to the seller).

When a transaction or contingent payment is made (e.g., authorized), data 125 is passed from the transaction payment processor 124 to a fee assessment engine 126 that facilitates the payment of a fee to the administrator 160. A fee authorization 170 is generated and presented to a participant financial institution 172 according to the transaction participant (or participants) proving the fee. For instance, where the seller 150 contracts with the administrator 160 of the transaction processor 120 to provide fees for transactions (e.g., as depicted by contract data 136), the participant financial institution is the seller 150's financial institution. Where the buyer contracts in a similar manner, the participant financial institution 172 is implemented with the buyer's financial 140. In other applications, more than one transaction party provides funds to cover the assessed fee. Furthermore, where processed internally to the transaction processor 120, in a manner similar to that discussed above with the contingent payment, the transaction processor 120 may selectively withhold a portion of a payment to provide the fee. For instance, where a seller that is paid also provides the fee, the transaction processor 120 withholds the fee from the payment, and provides the fee to the administrator 160.

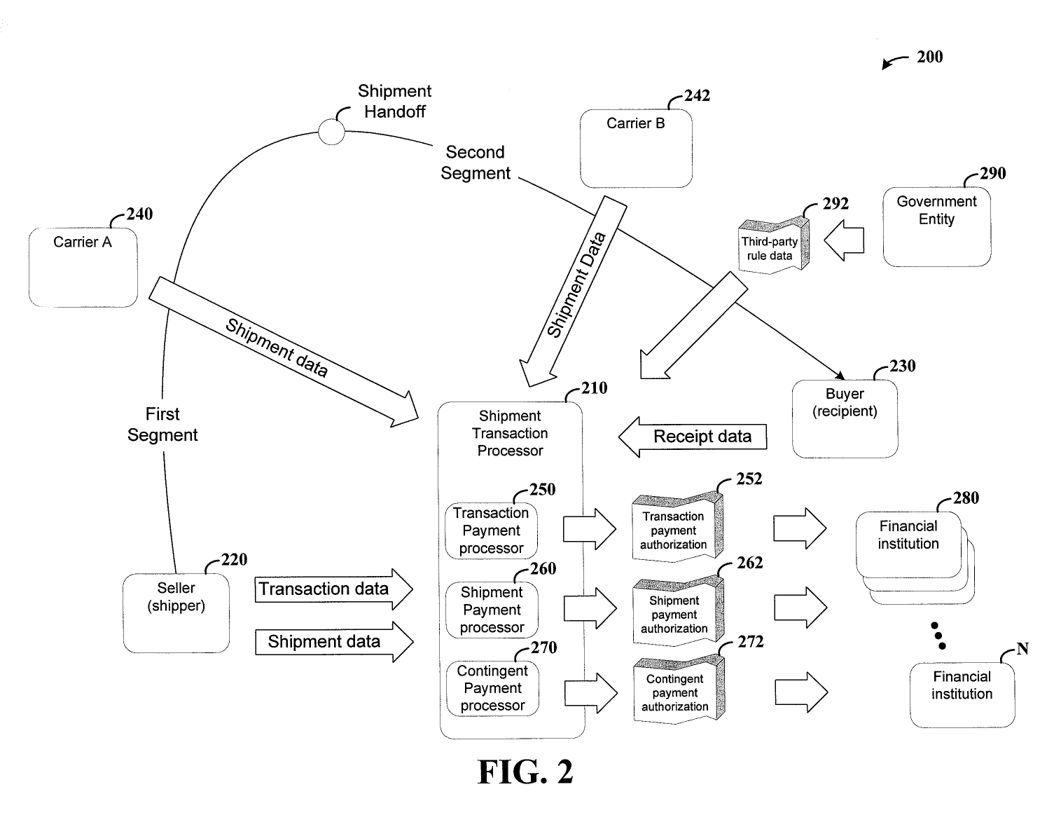

FIG. 2 shows an arrangement and approach 200 for the electronic processing of payment for a shipping transaction involving two or more carriers and respective shipping segments with related jurisdiction-based third-party payment, according to another example embodiment of the present invention. This approach is amenable to implementation with separate transactions between a shipper and different carriers (respectively as a buyer and sellers of shipping services), and between a shipper and an end-buyer recipient that receives shipment services supplied via the shipper.

In this context, a seller 220 sells shipping services to a buyer 230, and carriers A and B (240, 242) actually carry out the shipment. Such an approach may involve, for example, the shipment of goods on a first ocean-going freighter by carrier A (240), a shipment handoff between a first ocean-going freighter and another freighter, or land transportation carried out by carrier B (242). Various other types of carrier services may be effected in a similar manner.

A shipment transaction processor 210 includes a transaction payment processor 250, a shipment payment processor 260 and a contingent payment processor 270, respectively implemented with a computer programmed to audit and facilitate payment for a transaction (between a seller 220 and a buyer 230), a shipment (between the seller 220 and carriers 240, 242), and a contingent payment. The audit and payment functions are executed using profile and/or rules data for respective transaction participants. The respective payments are executed via electronic payment authorization data 252, 262 and 272, which are provided to one of a variety of financial institutions 280-N.

As described herein, the contingent payment as processed by the contingent payment processor 270 may be authorized in response to one or more of a variety of conditions, and sourced from one or more of a variety of entities. In one embodiment, the shipment transaction processor 210 generates contingent payment authorization 272 to provide a contingent payment to the seller 220, from a government entity 290, in response to one of carrier A and carrier B being a government-identified carrier. The government entity 290 provides rules data 292 that are used by the transaction processor 210 in identifying payments to be made. This approach is useful, for example, for government promotion of the use of a particular type of carrier, and as may be related to a particular type of shipment (e.g., a humanitarian aid shipment). For instance, a particular governing entity may wish to promote the use of carriers licensed by and/or otherwise facilitated with the governing entity, and a contingent payment may be made to offset additional costs borne by the seller 220 in using a government-sponsored carrier. In this context, the shipment transaction processor 210 can be programmed to generate the contingent payment authorization 272 in response to a payment to a particular carrier via shipment payment authorization 262, or in response to other data indicative of the carrier's participation in a shipment transaction.

In another embodiment, the shipment transaction processor 210 generates a third-party payment to a carrier 240, in response to completion of the carrier's portion of the shipment (i.e., a first segment), based upon shipment and/or receipt data received from the buyer 230. For instance, where the seller 220 contracts with the buyer 230 for a total shipment including first and second segments as shown, a contingent payment may be provided directly from the buyer's funds to pay for each respective segment separately. Payment to the carrier 240 is made directly from funds designated to the buyer 230. Effectively, payment is made to each carrier in an amount corresponding to a contract between the respective carrier and the seller. Payment is made to the seller 220 in an amount that corresponds to a contract between the seller and the buyer 230, less any amount paid to the carriers, with a residual amount, corresponding to a total shipment cost agreed upon between the seller 220 and buyer 230, going to the seller 220.

While exemplarily described using shippers and carriers, the embodiments described in connection with FIG. 2 may be implemented with a variety of different types of buyer and seller entities, as well as different suppliers (i.e., carriers, suppliers of other services, or suppliers of goods). Accordingly, different types of contingent payments may be made, based on conditions relating to the transaction being processed.

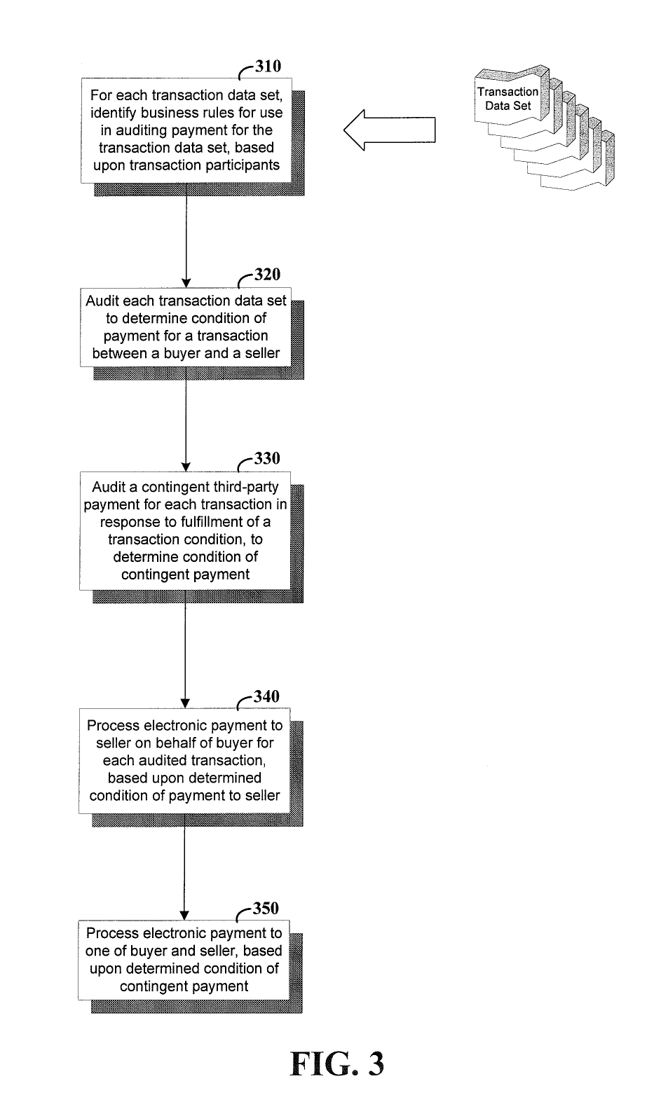

FIG. 3 shows a flow diagram for electronic transaction processing involving a third party payment, according to another example embodiment of the present invention. In the context of various example embodiments, the flow diagram in FIG. 3 is implemented as an algorithm programmed into a computer-based processor. Such an algorithm may be programmed, for example, into one or more of the processors as shown in the other figures and/or described herein.

At block 310, business rules are identified for each of a multitude of different transaction data sets as they are received. That is, each transaction data set pertains to a particular buyer and seller, yet the buyers and sellers for each data set may be different. With this approach, (central) transaction processing is carried out using different rules and/or algorithms as specific to each buyer/seller combination and, where appropriate, related third-party participant. Accordingly, the (central) transaction processing operates independently for each transaction, allowing a multitude of disparate transaction entities to transact with one another, according to predefined rules specific to each participant, with central execution of transaction functions.

At block 320, each transaction data set is audited, according to rules for one or more participants in the related transaction, to determine a condition of payment for payment to a seller. For instance, an amount in an invoice making part of the transaction data set may be audited and deemed payable, based upon information in the data set and rules for a buyer on behalf of which payment is to be made.

A contingent third-party payment is audited at block 330, in response to fulfillment of a transaction condition (e.g., as may be specified in the transaction data set), to determine a condition of contingent payment. Such a payment may be made based upon conditions such as those described above, which may include payment or performance for an underlying transaction, audited at block 320.

At block 340, electronic payment is processed to a seller on behalf of a buyer for each audited transaction data set (or a collection of such sets), based upon the determined condition of payment to a seller. At block 350, electronic payment is also processed for a third-party payment, with the recipient being one of a buyer and seller in the transaction for which the payment is processed, based upon rules for the contingent payment (e.g., as described above) and the determined condition of contingent payment.

Those of skill in the art will appreciate that the above-discussed approaches may be implemented using a variety of arrangements and processes. For example, the computer-based approaches shown and discussed in U.S. Pat. No. 5,910,896 (USBA.002PA, filed Nov. 12, 1996 and incorporated herein by reference) may be implemented for one or more of the various embodiments discussed herein, such as for auditing a transaction to determine whether a third-party payment can be made. Various aspects of the invention are directed to computer-based processors such as a computer or computer system, programmed (i.e., with an algorithm) to carry out the functions described herein. In addition, for general information regarding transaction processing, including computer-implemented processing, and for specific information regarding approaches that may be implemented in connection with various example embodiments herein, reference may be made to U.S. patent application Ser. No. 11/316,381 (USBA.133PA), entitled “Multi-party Transaction Processing System and Approach” and filed Dec. 22, 2005, and to U.S. patent application Ser. No. 11/120,629 (USBA.123PA), entitled “Transaction Data Exchange System and Approach” and filed May 3, 2005, which are fully incorporated herein by reference.

While certain aspects of the present invention have been described with reference to several particular example embodiments, those skilled in the art will recognize that many changes may be made thereto without departing from the spirit and scope of the present invention, aspects of which are set forth in the following claims.

What is claimed is:

1. A computer-based system for auditing transaction data for a multitude of disparate electronic transactions involving different transaction parties and operational configurations, the system comprising:
a computer-based auditing circuit configured, for each of a multitude of transaction data sets respectively pertaining to different transactions, each transaction involving parties including a buyer, seller and an independent third party on behalf of which a contingent electronic payment is provided to one of the transaction parties, to
retrieve stored business rules data for the buyer, business rules for the third party, and contract data for the transaction to which the transaction data set applies,
audit the transaction data set using a transaction-specific auditing function defined using the retrieved business rules data and contract data as inputs, to determine a condition of buyer-payment authorization for a payment to be made to the seller on behalf of the buyer, and
in response to the determined condition of buyer-payment authorization, audit the transaction data set using a third-party specific auditing function defined using a transaction condition fulfillment criterion specified in the business rules for the third party, to determine a condition of contingent third-party payment authorization; and
a computer-based payment processor circuit configured to
process electronic payment to the seller on behalf of the buyer in response to the determined condition of buyer-payment authorization, and
process payment to one of the buyer and the seller in response to the determined condition of third-party payment authorization.

2. The system of claim 1, wherein the auditing circuit is configured to reprogram itself on a transaction-by-transaction basis, respectively using program data in business rules for at least one of the buyer and the seller for determining the condition of buyer-payment authorization, and program data in business rules for the third party for determining a condition of contingent third-party payment authorization, and to maintain integrity of data used for auditing the transaction data sets based upon the parties participating in the transaction to which the transaction data sets apply.

3. The system of claim 1, wherein the independent third party is a government entity that provides payment incentives to buyers for transacting with sellers in accordance with criterion predefined in the government entity's business rules, and wherein the auditing circuit is programmed to audit the transaction data set to determine a condition of contingent third-party payment authorization by generating payment authorization data for authorizing payment from the government entity to the buyer in response to a condition of the transaction between the buyer and the seller satisfying the predefined criterion.

4. The system of claim 1, wherein the third-party business rules specify suppliers that must be used as a condition upon which a contingent third-party payment can be authorized, and wherein the auditing circuit is configured to audit the transaction data set using an identification of the specified suppliers and of the seller as inputs to determine a condition of third-party payment authorization that authorizes the contingent third-party payment in response to the seller identification matching the identification of one of the specified suppliers..

5. The system of claim 1, wherein the third-party business rules specify a seller characteristic as a condition upon which a contingent third-party payment can be authorized, and wherein the auditing circuit is configured to audit the transaction data set using the specified characteristic and predefined profile characteristics of the seller as inputs to determine a condition of third-party payment authorization that authorizes the contingent third-party payment in response to one of the predefined profile characteristics matching the third-party specified characteristic.

6. The system of claim 1, wherein the third-party business rules specify that a payment from the buyer to the seller is a condition upon which a contingent third-party payment can be authorized, and wherein the auditing circuit is configured to audit the transaction data set using the payment condition and the determined condition of buyer-payment authorization as inputs to determine a condition of third-party payment authorization that authorizes payment in response to the seller having been paid.

7. The system of claim 1, wherein the third-party business rules specify performance by the seller as a condition upon which a contingent third-party payment can be authorized, and wherein the auditing circuit is configured to audit the transaction data set using the specified performance and information in the transaction data set indicative of the seller's performance as inputs to determine a condition of third-party payment authorization that authorizes the contingent third-party payment in response to the seller having performed the specified aspect of the transaction.

8. The system of claim 1, wherein the system further includes a computer-based fee assessment circuit configured to generate fee data in response to each processed electronic payment to assess a transaction processing fee to at least one transaction party involved in the transaction for which the payment is processed.

9. The system of claim 1, wherein
the third-party business rules specify rebate rules upon which a rebate payment may be issued from a third-party supplier for transactions carried out between the buyer and a seller for goods provided by the third-party supplier,
the auditing circuit is configured to audit the transaction data set using the specified rebate rules as an input to determine a condition of third-party payment authorization that authorizes payment for the rebate to at least one of the buyer and the seller, and
the payment processor circuit is configured to process payment for the rebate to at least one of the buyer and the seller in response to the determined condition of third-party payment authorization for the rebate, using the rebate rules and information in the transaction data set to determine an amount of the rebate.

10. The system of claim 1, wherein
the third-party business rules specify subsidy rules upon which a subsidy payment may be issued from a third-party agency to a seller for transactions carried out between the seller and a buyer for goods provided by the seller,
the auditing circuit is configured to audit the transaction data set using the specified subsidy rules as an input to determine a condition of third-party payment authorization for the subsidy, and
the payment processor circuit is configured to process payment for the subsidy to the seller in response to the determined condition of third-party payment authorization for the subsidy, using the subsidy rules to determine an amount of the subsidy payment.

11. The system of claim 1, wherein the auditing circuit is configured to audit the transaction data set using third-party business rules defining early-payment discounts data based upon a timing characteristic of the buyer-payment authorization as an input, to determine a condition of third-party payment authorization for the payment of an early-payment discount.

12. The system of claim 1, wherein
the third-party business rules specify a payment criterion that is based upon the completion of a portion of a transaction between the third party and a buyer, the third party being the recipient of merchant offerings provided by sellers that contract with the buyer for respectively providing a portion of the merchant offerings,
the auditing circuit is configured to audit the transaction data set using a third-party specific auditing function, using the payment criterion and transaction data indicative of a completion characteristic for the transaction as inputs, to determine a condition of third-party payment authorization in response to one of the sellers performing a portion of the transaction, and
the payment processor circuit is configured to process payment for the portion of the transaction that is performed, in response to the determined condition of payment authorization.

13. A method for auditing transaction data for a multitude of disparate electronic transactions involving different transaction parties and operational configurations, the method comprising:
in a computer-based auditing circuit, for each of a multitude of transaction data sets respectively pertaining to different transactions, each transaction involving parties including a buyer, seller and an independent third party on behalf of which a contingent electronic payment is provided to one of the transaction parties,
retrieving stored business rules data for the buyer, business rules for the third party, and contract data for the transaction to which the transaction data set applies,
auditing the transaction data set using a transaction-specific auditing function, defined using the retrieved business rules data and contract data as inputs, to determine a condition of buyer-payment authorization for a payment to be made to the seller on behalf of the buyer, and
in response to the determined condition of buyer-payment authorization, auditing the transaction data set using a third-party specific auditing function defined using a transaction condition fulfillment criterion specified in the business rules for the third party, to determine a condition of contingent third-party payment authorization; and
in a computer-based payment processor circuit,
processing electronic payment to the seller on behalf of the buyer in response to the determined condition of buyer-payment authorization, and
processing third-party payment to one of the buyer and the seller in response to the determined condition of third-party payment authorization.

14. The method of claim 13, wherein auditing the transaction data set using a third-party specific auditing function defined using a transaction condition fulfillment criterion specified in the business rules for the third party includes, for each transaction data set, configuring the auditing circuit with program information specified in business rules for the third party to operate exclusively on behalf of the third party participant in the transaction data set.

15. The method of claim 13, wherein the independent third party is a government entity that provides payment incentives to buyers for transacting with sellers in accordance with criterion predefined in the government entity's business rules, and wherein auditing the transaction data set to determine a condition of contingent third-party payment authorization includes generating payment authorization data for authorizing payment from the government entity to the buyer in response to a condition of the transaction between the buyer and the seller satisfying the predefined criterion.

16. The method of claim 13, wherein the third-party business rules specify suppliers that must be used as a condition upon which a contingent third-party payment can be authorized, and wherein auditing the transaction data set includes using identification data for the specified suppliers and the seller as inputs to determine a condition of third-party payment authorization that authorizes the contingent third-party payment, in response to the seller identification matching the identification of one of the specified suppliers.

17. The method of claim 13, wherein the third-party business rules specify a seller characteristic as a condition upon which a contingent third-party payment can be authorized, and wherein auditing the transaction data set includes using the specified characteristic and predefined profile characteristics of the seller as inputs to determine a condition of third-party payment authorization that authorizes the contingent third-party payment in response to one of the predefined profile characteristics matching the third-party specified characteristic.

18. The method of claim 13, wherein the third-party business rules specify that a payment from the buyer to the seller is a condition upon which a contingent third-party payment can be authorized, and wherein auditing the transaction data set includes using the payment condition and the determined condition of buyer-payment authorization as inputs to determine a condition of third-party payment authorization that authorizes payment in response to the seller having been paid.

19. The method of claim 13, wherein the third-party business rules specify performance by the seller as a condition upon which a contingent third-party payment can be authorized, and wherein auditing the transaction data set includes using the specified performance and information in the transaction data set indicative of the seller's performance as inputs to determine a condition of third-party payment authorization that authorizes the contingent third-party payment in response to the seller having performed the specified aspect of the transaction.

20. The method of claim 13, further including, in a computer-based fee assessment circuit, generating fee data in response to each processed electronic payment to assess a transaction processing fee to at least one transaction party involved in the transaction for which the payment is processed.

21. The method of claim 13, wherein,
the third-party business rules specify rebate rules upon which a rebate payment may be issued from a third-party supplier for transactions carried out between the buyer and a seller for goods provided by the third-party supplier,
auditing the transaction data set includes using the specified rebate rules as an input to determine a condition of third-party payment authorization that authorizes payment for the rebate to at least one of the buyer and the seller, and
processing third-party payment includes processing payment for the rebate to at least one of the buyer and the seller in response to the determined condition of third-party payment authorization for the rebate, using the rebate rules and information in the transaction data set to determine an amount of the rebate.

22. The method of claim 13, wherein
the third-party business rules specify subsidy rules upon which a subsidy payment may be issued from a third-party agency to a seller for transactions carried out between the seller and a buyer for goods provided by the seller,
auditing the transaction data set includes using the specified subsidy rules as an input to determine a condition of third-party payment authorization for the subsidy, and
processing third-party payment includes processing payment for the subsidy to the seller in response to the determined condition of third-party payment authorization for the subsidy, using the subsidy rules to determine an amount of the subsidy payment.

23. The method of claim 13, wherein the auditing circuit is configured to audit the transaction data set using third-party business rules defining early-payment discounts data based upon a timing characteristic of the buyer-payment authorization as an input, to determine a condition of third-party payment authorization for the payment of an early-payment discount.

24. The method of claim 13, wherein
the third-party business rules specify a payment criterion that is based upon the completion of a portion of a transaction between the third party and a buyer, the third party being the recipient of merchant offerings provided by sellers that contract with the buyer for respectively providing a portion of the merchant offerings,
auditing the transaction data set includes using a third-party specific auditing function, using the payment criterion and transaction data indicative of a completion characteristic for the transaction as inputs, to determine a condition of third-party payment authorization in response to one of the sellers performing a portion of the transaction, and
processing third-party payment includes processing payment for the portion of the transaction that is performed, in response to the determined condition of payment authorization.
